(19) United States
(12) Patent Application Publication
(10) Pub. No.: US 2010/0282339 A1
(43) Pub. Date: Nov. 11, 2010

(54) HOSE REEL

(76) Inventor: Harold Lee Richardson, Windsor, CA (US)

Correspondence Address: Bay Area Technology Law Group PC, Suite 404, 500 Sansome Street, San Francisco, CA, 94111, US

(21) Appl. No.: 12/435,914

(22) Filed: May 5, 2009

(51) Int. Cl. A01M 7/00

(52) U.S. Cl. 137/355.12

(57) ABSTRACT

A device for the capture and pay out of an in-sink water spray hose, the spray hose having a first end connected to a water service line and a second end connected to an in-sink spray nozzle. The device is positioned between first and second ends of the spray hose and includes a clamp for releasably attaching the device to the spray hose proximate its first end. A housing is provided having a length and width and an open top. The housing includes a weighted pulley wheel rotatable within the housing and moveable along the length of the housing, the weighted pulley being characterized as being freewheeling as to not be appended to side walls of the housing. The pulley has a diameter greater than the width of the container as well as a track diameter smaller than the pulley diameter to prevent the sprayer hose from dislodging from the weighted pulley once seated thereon.

### TECHNICAL FIELD

The present invention, in general relates to hose reels and, more particularly, to reels that are used proximate a sink to contain a hose of a sink sprayer.

### BACKGROUND OF THE INVENTION

Most kitchen sinks have an extendible sprayer device that is disposed in a receptacle beside the sink's main faucet. The spray device may actually be a part of the faucet and adapted to extend therefrom.

In any case, the sprayer is attached to a hose and is adapted to extend from its receptacle for use. The most typical use given to such a sprayer is to rinse dishes before hand-washing them or before their insertion into a dishwasher.

The problem is that there may be numerous objects disposed under a sink that can obstruct and interfere with the unencumbered extension and retraction of the hose. There are always plumbing conduits running to the sink and there may be conduit extending to a dishwasher, a garbage disposer, and usually there are valves for the hot and cold water supply that can snag the sprayer hose.

It is not uncommon for people to attempt to pull the hose and to have it snag, for example, on a valve that it has coiled around, preventing its extension.

It is also not uncommon for the hose to encounter resistance when it is retracted, making retraction a problem as well. The resistance during retraction may be due to the hose contacting an object, as mentioned above, or it may simply be due to resistance between the hose and its surroundings as it retracts normally. In either event, it is not unusual for users to have to force, or push, the hose back into its fully retracted position. This takes both time and effort.

Further, heretofore it has been impossible to adapt a universal hose reel to work with all sink sprayers. The question of varying fit and the need for diverse mounting brackets has prevented a ready solution to this problem.

Also, the time to install such a device would need to be short, so as to not incur substantial plumbing expenses. Ideally such a device should be capable of being retrofitted into existing sinks by non-skilled labor, for example the do-it-yourself person.

Accordingly, there exists today a need for a hose reel that is adapted for use with a wide variety of kitchen sprayers.

Clearly, such an apparatus would be a useful and desirable device.

It is thus an object of the present invention to provide a hose reel that is inexpensive to manufacture.

It is also an important object of the invention to provide a hose reel that is inexpensive to install.

Another object of the invention is to provide a hose reel that can be installed by unskilled labor.

Still another object of the invention is to provide a hose reel that can be used with new sink installations.

Still yet another object of the invention is to provide a hose reel that can be adapted for use with existing sinks.

Yet another important object of the invention is to provide a hose reel that is adapted for use with a wide variety of sink sprayers.

Still yet another important object of the invention is to provide a hose reel that attaches to the hose.

Still an additional object of the invention is to provide a hose reel that includes internal means for reducing friction within a container.

Yet an additional object of the invention is to provide a hose reel that includes a plurality of exit points at the top, each exit point including a roller to reduce friction.

Still another object of the invention is to provide a hose reel that allows a water sprayer to fully retract into its receptacle when not in use.

An additional object of the invention is to provide a hose reel that reduces friction when a hose is retracted back into the reel.

Still yet an additional object of the invention is to provide a hose reel that includes a free floating weighted pulley therein that is adapted to supply a force to urge the hose back into the reel.

### SUMMARY OF THE INVENTION

A device for the capture and pay out of an in-sink water spray hose, the spray hose having a first end connected to a water service line and a second end connected to an in-sink spray nozzle. The device is positioned between first and second ends of the spray hose and includes a clamp for releasably attaching the device to the spray hose proximate its first end A housing is provided having a length and width and an open top. The housing includes a weighted pulley wheel rotatable within the housing and moveable along the length of the housing, the weighted pulley being characterized as being freewheeling as to not be appended to side walls of the housing. The pulley has a diameter greater than the width of the container as well as a track diameter smaller than the pulley diameter to prevent the sprayer hose from dislodging from the weighted pulley once seated thereon.

### BRIEF DESCRIPTION OF THE FIGURES

FIG. 1 is a cross sectional view of a hose reel installed under a kitchen sink.

FIG. 2 is a top view of the hose reel of FIG. 1, absent the hose for clarity of view.

### DETAILED DESCRIPTION OF THE INVENTION

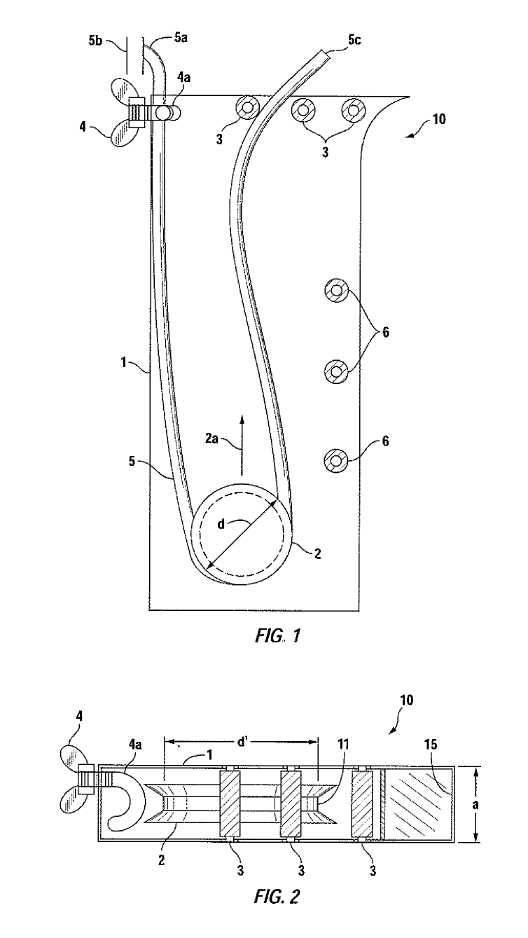

Referring to FIG. 1 and FIG. 2 is shown, a hose reel, identified in general by the reference numeral 10.

A container 1 includes a wing nut 4 and a J-clamp 4a proximate a top-edge of the container 1. The J-clamp 4a includes a curved portion that resembles a “J” shape. The straight portion is threaded and the wing nut 4 cooperates with the threads.

The straight portion of the J-clamp 4a passes through a hole that is provided through the top-edge of the container 1. As the wing nut 4 is tightened, the curved portion of the J-clamp 4a is drawn closer to the edge (i.e., side) of the container 1.

A sink sprayer hose 5 is included with a kitchen sink (not shown). The sink is disposed slightly above and to the side of the container 1.

The sprayer hose 5 is also known as a sink aerator hose and is attached at a first end 5a to the combined hot/cold inlet conduit 5b that supplies water to the kitchen faucet (not shown) disposed above the container 1. A second end 5c of the hose 5 passes through an opening in the sink and is attached to a hand-held sprayer unit (not shown) that provides a shower of water useful for cleaning dishes and other functions.

In normal use, the hand-held sprayer unit fits into a receptacle that is disposed in the opening in the sink. The hand-held sprayer unit is grasped and pulled (i.e., extended) out from the receptacle and opening for use to direct a flow/shower of water where desired. Normally, a valve is used to enable or disable the flow of water.

When finished, it is urged back into its receptacle. The quantity of hose 5 that has been pulled through the opening must be urged back into the opening and down under the sink.

To mount (attach) the hose reel 10, the wing-nut 4 is loosened and the curved portion of the J-clamp 4a is placed around the hose 5, as close to the first end 5a of the hose 5 as possible.

The wing-nut 4 is then tightened around the hose 5 an amount sufficient to hold the weight of the hose reel 10 and hose 5. The hose 5 is pinched between the curved portion of the J-clamp 4a and an interior side wall of the container 1.

The wing-nut 4 is not over-tightened so as to prevent pinching shut the hose 5 which could restrict the flow of water through the hose 5.

The hose 5 is routed so that it passes under a weighted wheel 2 that resembles a pulley but is free to rise or fall up and down within the container 1. The hose 5 extends out of the top of the container 1 wherever the opening (i.e., the receptacle that retains the hand-held sprayer unit) is in the sink above for the hose 5 to pass through.

A plurality of top rollers 3 are each removable, for removing the wheel 2, dropping the hose 5 into the container 1, and placing the wheel 2 over the hose 5 in the container 1 during installation. The hose 5 extends out through the top of the container 1 between any two of the top rollers 3.

Accordingly, the exit point of the hose 5 from the container 1 is selected so that the distance from the hose first end 5a to the opening in the sink through which the hose 5 passes is as close as possible as the distance from the J-clamp 4a to the space intermediate any two of the top rollers 3. In other words, the housing is sized such that the distance between the point of connection of the water line at the first end of the spray hose to the point of connection of the second end of the spray hose to the water nozzle is approximately equal to the maximum length of the spray hose residing within the housing. Thus, as the spray nozzle is pulled from its at-rest position by a user, the amount of hose that is paid out causes pulley to rise within housing 1 thus not restricting the user's ability to pull sufficient hose length from its receptacle. As such, no restriction is experienced by a user, the only sensation being that the spray hose is now smoothly and conveniently made available and when the spray nozzle is no longer necessary, that the spray hose smoothly withdraws within its receptacle upon the urging of pulley 2.

The top rollers 3 are reinstalled with the hose 5 exiting where desired. The top rollers 3 can be secured to the top of the container 1 as desired, for example by a threaded bolt and nut passing through each of the top rollers 3, or by a friction fit into a pair of oppositely disposed recesses in the side walls of the container 1.

The top rollers 3 bear against the hose 5 from time to time, which helps to facilitate the extension and retraction of the hose 5 back into the container 1.

During use, the hand-held sprayer unit (i.e., the sink aerator) is grasped and extended for use. As the hand-held sprayer unit is pulled away from its receptacle-opening the hose 5 causes the pulley 2 to rise in the container 1 as shown by arrow 2a.

When use of the hand-held sprayer unit is complete it is directed back towards its receptacle-opening in the sink. The weight of the pulley 2 helps urge (i.e., pull) the hose 5 back down into the container 1. Accordingly, the pulley 2 descends in the container 1 in a direction that is opposite that shown by arrow 2a. The pulley 2 rotates easily as the hose 5 is extended or retracted thereby greatly reducing friction and easing both extension and retraction.

The top rollers 3 rotate as the hose 5 makes contact with either of the pair of top rollers 3 it is disposed between when it is either extended out of the container 1 or retracted back into the container 1, thereby further lessening friction.

A plurality of vertically spaced-apart side rollers 6 are included in the container 1 proximate a side of the container 1 that is opposite to that where the J-clamp 4a is disposed. The side rollers 6 are not removable and are used to reduce friction of the hose 5 against the side of the container 1 when the hose 5 is either extended or retracted.

The container 1, as shown, includes four side walls and is open at the top where the top rollers 3 are located. A bottom end that is opposite the top preferably is either open or includes a plurality of openings so that any water or other debris that might collect on the hose 5 and be pulled into the container 1 when the hose is retracted, can be permitted to fall out of the container 1.

Also referring in particular to FIG. 2, the pulley 2 is disposed between the sidewalls of the container 1 so that pulley 2 cannot be displaced sufficiently far to either side so as to cause the hose 5 (not shown in this drawing) to become disengaged from a position of cooperation with the pulley 2. Accordingly, as the pulley 2 goes up and down, the hose 5 is always engaged in track 11 of the pulley.

An important feature of the present invention involves the operation of pulley 2 and particularly as to its interaction with container 1. As is apparent from the drawings, pulley 2 is freewheeling; that is, pulley 2 is not appended in any way to the side walls of container 1. By eliminating an axle through pulley 2 that would engage a track in container 1, pulley 2 is relatively free to rotate and move along the length of container 1 and the possibility that hose 5 would hang upon an axle is obviously eliminated. However, in achieving these goals, certain design parameters must be observed. Specifically the diameter “d” of pulley 2 must be larger than the width “a” of container 1 to prevent pulley 2 from assuming an orientation whereby its axis is perpendicular to short dimension “a.” In other words, pulley 2 is maintained in the orientation depicted in FIG. 2. Also, the diameter “d” of track 11 must be sufficiently smaller than diameter “d” of pulley 2 to insure that hose 5 remains seated within track 11 even if pulley 2 varies from its precise orientation shown in FIG. 2 in which its axis moves from its parallel orientation to one that is diagonal to side wall 15.

The invention has been shown, described, and illustrated in substantial detail with reference to the presently preferred embodiment. It will be understood by those skilled in this art that other and further changes and modifications may be made without department from the spirit and scope of the invention which is defined by the claims appended hereto.

What is claimed is:

1. A device for the capture and payout of an in sink water spray hose, said spray hose having a first end connected to a water service line and a second end connected to an in-sink spray nozzle, said device being positioned between said first and second ends and comprising a clamp for releasably attached said device to said spray hose proximate the first end thereof, a housing having a length and width and a substantially open top and a weighted pulley wheel rotatable within said housing and movable along said length, said weighted pulley being characterized as being freewheeling as to not be appended to side walls of said housing, having a diameter greater than said width of said container and having a track diameter smaller than said weighted pulley diameter to substantially prevent said spray hose from dislodging from said weighted pulley once seated thereon.

2. The device of claim 1 wherein said weighted pulley is of sufficient means as to urge said spray hose into said container.

3. The device of claim 1 further comprising a plurality of rollers in spaced apart relationship positioned across said substantially open top for guiding said spray hose from and to the container of said housing.

4. The device of claim 3 wherein said plurality of rollers are selectively removable from said housing.

5. The device of claim 1 further comprising a plurality of rollers positioned within said housing and oriented substantially parallel to said width for reducing friction of said spray hose as it moves within said housing.

6. The device of claim 1 wherein said housing is sized such that the distance between the point of connection of said water line and said first end of said spray hose to said water nozzle is approximately equal to the maximum length of spray hose residing within said housing.
